(19) United States
(12) Patent Application Publication
(10) Pub. No.: US 2011/0250253 A1
(43) Pub. Date: Oct. 13, 2011

(54) Antimicrobial treatment of synthetic nonwoven textiles

(76) Inventors: Glen T. Cunkle, Stamford, CT (US); Carmen Hendricks-Guy, White Plains, NY (US); Ted Deisenroth, Brookfield, CT (US)

(21) Appl. No.: 13/082,443

(22) Filed: Apr. 8, 2011

Related U.S. Application Data
(60) Provisional application No. 61/323,115, filed on Apr. 12, 2010.

(51) Int. Cl. A01N 25/34; A01P 1/00

(52) U.S. Cl. 424/404; 424/402

(57) ABSTRACT

Highly active, leach-resistant, antimicrobial nonwoven textiles are prepared by treating at least one surface of the nonwoven material with an anionic polyelectrolyte, such as carboxymethyl cellulose, alginic acid, poly(acrylic acid) etc and at least one select quaternary ammonium antimicrobial agent. The textiles of the invention, and products produced from them, exhibit a highly effective quick kill rate, for example a log 4 CFU reduction within a 5 minute contact time, against microbes such as fungi and gram (−) and gram (+) bacteria.

This application claims the benefit of U.S. Provisional Application No. 61/323,115 filed Apr. 12, 2010 herein incorporated entirely by reference.

Antimicrobial textiles, characterized by fast action against pathogens, durability and leach-resistance and articles thereof, are prepared by treating at least one surface of the textile with an anionic polyelectrolyte, such as carboxymethyl cellulose, alginic acid, poly(acrylic acid) etc and at least one select quaternary ammonium antimicrobial agent.

### BACKGROUND

The prevalence of nosocomial infections has serious implications for both patients and healthcare workers. Nosocomial infections are those that originate or occur in a hospital or long-term care, hospital-like settings. These hospital acquired infections (HAIs) can be quite serious and dangerous as many of the pathogens found in healthcare settings can be resistant to typical antibiotics and thus more difficult to treat.

Hospital-acquired infections may develop from surgical procedures, catheters placed in the urinary tract or blood vessels, or from material from the nose or mouth that is inhaled into the lungs. For example, common HAIs include urinary tract infections, pneumonia from endo-tracheal ventilators, blood-born pathogen contaminations, and surgical wound infections.

The occurrence and spread of nosocomial infections is greatly dependent on the microbes' ability to colonize and survive within institutions, for example, on hospital gowns, surgical equipment, medical devices, gloves, bed clothes etc. Transmission of microbes from one contaminated surface to an uncontaminated surface, for example, a bed sheet, skin or an open wound, spreads the diseases. The microbes may already be present in the patient's body or may come from the environment, contaminated hospital equipment, healthcare workers, or other patients.

Hospitals and other healthcare facilities have developed programs to prevent nosocomial infections. Frequent hand washing by healthcare workers and visitors, the extensive use of masks, eye protections, face shields and gloves to prevent exposure to blood, body fluids, secretions, excretions, contaminated items, mucus membrane and non-intact skin. Gowns are worn to protect skin and avoid contamination of clothing during splashes of blood or body fluids. Medical instruments and equipment are sterilized to ensure they are not contaminated.

Despite hospital infection control programs a significant number of infections still occur. The current procedures are not sufficient. Despite enforcement of precautionary measures (e.g. washing hands, wearing gloves, face mask and cover gowns), HAIs still occur predominately via contact transfer. That is, individuals who contact pathogen-contaminated surface such as hands, clothing and/or medical instruments, can still transfer the pathogens from one surface to another immediately or within a short time after initial contact.

For example, a surgical mask or a cover gown worn to prevent the wearer from becoming exposed to microbes is discarded immediately after use. However, any microbes transferred to the surface of the mask or gown can be transferred to any surface contacted by the discarded item, and then from that surface to another surface and so on. It is important therefore, that the microbes transferred to the mask or gown be killed before the item comes into contact with a non-protected surface. Conventional antimicrobial treatments are not typically effective enough at killing and immobilizing pathogens on such surfaces in the short period of time required, e.g., 5 minutes or less.

In addition to being lethal to pathogens, the compatibility of the anti-microbial treatment with these fabrics or material and durability of the treatment once applied must be taken into account. Loss of the antimicrobial to the environment during use or storage of the item should be prevented for efficacy to be retained and to prevent build up of the antimicrobials in soil, water and animals etc. A successful solution should provide an antimicrobial material that is extremely fast acting in the destruction of pathogens and which will not leach the actives to the environment.

A large number of fast acting cationic antimicrobials such as quaternary ammonium salts are known but need to be specifically formulated for use in such areas as medical textile applications. For example, synthetic nonwoven textiles, such as non-woven polypropylene fabrics, are widely used in hospital and other medical settings yet until now the application of cationic antimicrobials to synthetic nonwoven fabrics to produce a fast acting and durable antimicrobial finish has not been realized.

U.S. Pat. No. 4,615,937 discloses an antimicrobially active non-woven web comprising synthetic and/or cellulosic fibers, organo-silicon quaternary ammonium salts, and a suitable latex binder.

U.S. Pat. No. 2,931,753 discloses salts of polysaccharide carboxylic acids, such as carboxymethyl cellulose, and quaternary ammonium salts which can be formed on cellulosic fabrics to provide an antimicrobial surface treatment.

U.S. Pat. No. 2,984,639 discloses a water insoluble, germicidal material which is a salt formed from a quaternary amine and a synthetic, carboxylic acid containing polymer. The salt is soluble in organic solvents and can be used to form films or can be added to film forming compositions such as paints.

U.S. Pat. Nos. 4,783,340 and 5,158,766 disclose an antimicrobial surface treatment, well suited for spraying or other application to hard surfaces, comprising ammonium salts and anionic polymers.

The aforementioned patents, incorporated herein by reference, are silent regarding the preparation of quick acting antimicrobial treatments for textile surfaces comprised of synthetic polymers.

US Pub App. No. 2007/0048356 discloses the use of PHMB with a second antimicrobial agent to create an antimicrobial coating for nonwovens. US Pub App. No. 2007/0042198 discloses creating an antimicrobial surface using organo-silicon quaternary ammonium salts and cationic, hydrophilic polymers such as PEI and PHMB. The disclosures of both applications are incorporated herein by reference.

U.S. Pat. No. 4,721,511, incorporated herein by reference, discloses leach-resistant antimicrobial non-woven fabrics comprising a non-woven substrate, e.g. cellulose, polyethylene or polypropylene; a silicone quaternary amine, and an organic titanate useful as a crosslinking agent for the silicone quaternary amine.

Despite the many advancements in this area, there is still a need for antimicrobial textiles, especially non-woven fabrics comprising useful synthetic polymers, such as polypropylene, PET and other synthetic fibers, which possess the ability to quickly, and efficiently kill pathogens upon brief exposure, e.g., reducing the bacterial population 99.99% within 30 minutes and preferably, reducing the bacterial population 99.99% within 5 minutes of contamination.

It has been found that treating synthetic textile materials with certain quaternary ammonium compounds and select anionic polymers provides the textile materials with a durable, non-leaching, antimicrobial surface with extremely efficient and quick killing antimicrobial activity.

### SUMMARY OF THE INVENTION

The invention encompasses several embodiments: An antimicrobial textile, a method for producing an antimicrobial textile, an article containing the antimicrobial textile and a kit of parts for the making or manufacture of a antimicrobial textile.

Accordingly the invention embodies an antimicrobial textile comprising

a) a treated textile substrate comprised of fibers formed from synthetic polymer, said treated substrate comprises
b) 0.1% to 10 wt. % of an anionic polyelectrolyte, and
c) 0.1% to 10 wt. % of a cationic antimicrobial agent of the formula:

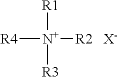

wherein R₁, R₂, R₃ and R₄ are independent of each other C₁₋₂₀ alkyl, said alkyl substituted by one or more hydroxy or benzyloxy group and/or interrupted by one or more oxygen, C₇₋₁₅ aralkyl, or said aralkyl substituted by one or more C₁₋₂₀ alkyl, hydroxy, C₁₋₂₀ alkyloxy and/or benzyloxy groups, and
X⁻ is a halide, hydroxide, phosphate, phosphonate, carbonate, sulfate or carboxylate anion,
the synthetic polymer is a polyolefin, polyester, polyamide, polylactic acid, polyglycolic acid or mixtures thereof,
and
d) optionally a nonionic surfactant,
and the wt. % is based on the total weight of the treated antimicrobial textile.

A method of producing an antimicrobial fibrous textile or an article containing an antimicrobial fibrous textile comprised of fibers formed from synthetic polymer comprising the steps of treating at least one surface of the textile with an anionic polyelectrolyte and a cationic antimicrobial agent of the formula:

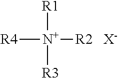

wherein R₁, R₂, R₃ and R₄ are independent of each other C₁₋₂₀ alkyl, said alkyl substituted by one or more hydroxy or benzyloxy group and/or interrupted by one or more oxygen, C₇₋₁₅ aralkyl, or said aralkyl substituted by one or more C₁₋₂₀ alkyl, hydroxy, C₁₋₂₀ alkyloxy and/or benzyloxy groups, and
X⁻ is a halide, hydroxide, phosphate, phosphonate, carbonate, sulfate or carboxylate anion, preferably chloride, bromide, iodide, nitrate, methosulfate or acetate,
wherein the treated textile is characterized by a reduction in microbial activity of at least log 4 against gram positive and gram negative bacteria within 30 minutes of contamination, preferably within 5 minutes according to a modified version of American Association of Textile Chemists and Colorists (AATCC) standard 100-1999, and said synthetic polymer is a polyolefin, polyester, polyamide, polylactic acid, polyglycolic acid or mixtures thereof.

Furthermore a kit of parts is envisioned for the manufacture of an antimicrobial nonwoven textile, comprising a first part (A) comprising an anionic polyelectrolyte and a second part (B) comprising a cationic antimicrobial agent of the formula:

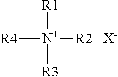

wherein R₁, R₂, R₃ and R₄ are independent of each other C₁₋₂₀ alkyl, said alkyl substituted by one or more hydroxy or benzyloxy group and/or interrupted by one or more oxygen, C₇₋₁₅ aralkyl, or said aralkyl substituted by one or more C₁₋₂₀ alkyl, hydroxy, C₁₋₂₀ alkyloxy and/or benzyloxy groups, and
X⁻ is a halide, hydroxide, phosphate, phosphonate, carbonate, sulfate or carboxylate anion preferably chloride, bromide, iodide, nitrate, methosulfate or acetate, which parts when applied to the textile or fiber forming the textile, form an antimicrobial textile according to claim 1.

### DESCRIPTION OF THE INVENTION

### The Antimicrobial Textile

The antimicrobial textile may be any textile or fabric. The textile is comprised of fibers and the fibers are formed from synthetic polymers.

The synthetic polymers are normally elastic or non-elastic thermoplastics.

The synthetic polymers making up the fibers are preferably selected from the group consisting of polyolefin, polyester, polyamide, polylactic acid, polyglycolic acid and mixtures thereof.

All of the above listed polymer types, polyolefin, polyester etc. include homopolymers, copolymers, terpolymers etc. Thus a polyolefin polymer may comprise polyethylene and polypropylene and/or styrene copolymers. The polyesters may comprise copolymers such as PET (polyethylene terephthalate) or PEN (Polyethylene naphthalate).

Most preferably the synthetic polymers are selected from the group consisting of polyolefin, polyester, polyamide and mixtures thereof, especially for example, polypropylene, polyethylene, polypropylene/polyethylene copolymers, PET, PEN, Nylon and the like.

Polyolefin fibers are especially preferred.

Polyolefins for example, include polypropylene, polyethylene, copolymers of ethylene and propylene, polybutylene, styrenic polymers and copolymers, metallocene-catalyzed polyolefins and mixtures thereof.

Polypropylene is a particularly preferred synthetic fiber material.

The textile may be woven or nonwoven but is preferably a nonwoven.

More than one type of synthetic polymer may be present. Naturally occurring polymers may also be present.

The synthetic polymer may be virtually any architecture but preferably will be random or block architecture.

### The Anionic Polyelectrolyte

The anionic polyelectrolytes, are those which will form a water insoluble complex with cationic antimicrobial agent and can be naturally occurring, synthetic or synthetically modified natural polymers. These anionic polyelectrolytes include cellulose, carboxy containing cellulose derivatives such as carboxy methyl cellulose, alginic acid and pectic acid, carboxy containing polysaccharides, carboxy containing starches such as carboxy methyl or ethyl starch, synthetic polymers prepared from ethylenically unsaturated carboxylic acid monomers and the like. For example, the anionic polyelectrolytes are selected from the group consisting of carboxymethyl cellulose, alginic acid, polymers and copolymer of acrylic acid or methacrylic acid, polymers and copolymer of maleic acid, itaconic or crotonic acid and mixtures thereof.

Polymers and copolymer of acrylic acid or methacrylic acid, for example would include such polymers as poly(ethylene-co-acrylic acid), poly(acrylamide-co-acrylic acid), poly(methacrylic acid) and copolymers of acrylic acid and methacrylic acid.

The anionic polyelectrolyte is preferably carboxymethyl cellulose, alginic acid, poly(ethylene-co-acrylic acid) or polyacrylic acid, most preferably carboxymethyl cellulose, alginic acid or poly(ethylene-co-acrylic acid).

When the polyelectrolyte is a carboxy containing cellulose, starch or alginic acid the charge density may be expressed as degree of substitution. Thus is the polyelectrolyte is carboxymethyl cellulose the degree of substitution may range from about 0.1 to about 3.0, preferably from about 0.5 to about 1.8 or more preferably from about 0.6 to about 1.4.

The weight average molecular weight based (Mw) of the anionic polyelectrolyte is typically about 1,000 to about 5,000,000 Daltons, preferably about 10,000 to about 2,000,000, most preferably about 25,000 to about 500,000.

The molecular weight specified is a preferably weight average molecular weight (M_{w}) which can be determined by a typical light scattering method or a GPC (gel permeation chromatography) method.

More than one anionic polyelectrolyte may be used. Combinations of synthetic and carboxy containing natural polymers are envisioned as the anionic polyelectrolyte. Combinations of several synthetic anionic polyelectrolytes are possible.

### The Cationic Antimicrobial

The cationic antimicrobial embraces materials such as

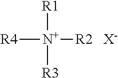

wherein R₁, R₂, R₃ and R₄ are independent of each other C₁₋₂₀ alkyl, said alkyl substituted by one or more hydroxy or benzyloxy group and/or interrupted by one or more oxygen, C₇₋₁₅ aralkyl, or said aralkyl substituted by one or more C₁₋₂₀ alkyl, hydroxy, C₁₋₂₀ alkyloxy and/or benzyloxy groups, and
X⁻ is a halide, hydroxide, phosphate, phosphonate, carbonate, sulfate or carboxylate anion, for example, chloride, bromide, iodide, nitrate, methosulfate or acetate.

C₁-C₂₀ alkyl (as well as, for example C₆-C₂₀-, C₁₀-C₂₀-, C₁₀-C₁₈-C₁-C₁₂-, C₁-C₈-, C₁-C₆- or C₁-C₄ alkyl) is a branched or unbranched alkyl chain containing the that number of carbon atoms, which include for example, methyl, ethyl, propyl, butyl, pentyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, isopropyl, isobutyl, tert-butyl, isopenty, neopentyl, 2-ethylhexyl, iso-octyl, tert octyl and the like.

Likewise, alkoxy, such as C₁-C₂₀-, C₁-C₁₂-, C₁-C₁₀-, C₁-C₈-, C₁-C₆- or C₁-C₄-alkoxy is a branched or unbranched alkyl chain containing the specified number of carbons which are connected to the rest of the compounds through an oxygen atom and includes for example, methoxy, ethoxy, propoxy, isopropoxy, n-butyloxy, sec-butyloxy, iso-butyloxy, tert-butyloxy, pentyloxy, hexyloxy, heptyloxy, 2,4,4-trimethylpentyloxy, 2-ethylhexyloxy, octyloxy, nonyloxy, decyloxy or dodecyloxy, for example, methoxy, ethoxy, propoxy, isopropoxy, n-butyloxy, sec-butyloxy, iso-butyloxy, tert-butyloxy.

C₇₋₁₅ aralkyl is for example benzyl, phenethyl, phenypropyl, cumyl, napthylmethyl, napthylethyl, napthylpropyl and the like.

The cationic antimicrobials can be selected from mono-long-chain, tri-short-chain tetraalkyl ammonium compounds; di-long-chain, di-short-chain tetraalkyl ammonium compounds; trialkyl, mono-benzyl ammonium compounds, and mixtures thereof. By “long” chain is meant alkyl of 6 or more carbon atoms. By “short” chain is meant alkyl of 5 or fewer carbon atoms. Typically, at least one of the groups R₁, R₂, R₃ and R₄ is a long chain alkyl or a benzyl group.

Preferably at least one of R₁, R₂, R₃ and R₄ is an alkyl group of 6 or more carbon atoms or a benzyl group.

Most preferably at least one of the groups R₁, R₂, R₃ and R₄ is an C₆-C₂₀ alkyl or a benzyl group. It is especially preferred that at least one of R₁, R₂, R₃ and R₄ is a C₁₀-C₂₀ alkyl or a benzyl group.

In one embodiment, the cationic antimicrobial is selected from alkyldimethylbenzylammonium compounds, didecyldimethylammonium compounds and cetyltrimethylammonium compounds, for example alkyldimethylbenzylammonium chlorides, didecyldimethylammonium chloride and cetyltrimethylammonium chloride. In one particular embodiment the cationic antimicrobial is cetyltrimethylammonium chloride.

Preferred cationic antimicrobials are alkyldimethylbenzylammonium salt, benzethonium salt, didecyldimethylammonium salt and cetyltrimethylammonium salt.

A most preferred cationic antimicrobial is cetyltrimethylammonium salt.

More than one tetraalkyl ammonium compound may be used and other biocides may also be present.

In addition to the quaternary ammonium salt required in the invention, other antimicrobial agents may also be added, for example, a biguanide such as poly-hexamethylene biguanide hydrochloride, a chlorohexine, an alexidine, and relevant salts thereof, stabilized oxidants including stabilized peroxides, sulfides, sulfites such as sodium metabisulfite, polyphenols, bis-phenols including triclosan and hexachlorophene etc, other quaternary ammonium compounds including quaternary ammonium siloxanes, cetyl pyridinium chloride, quaternized cellulose and other quaternized polymers; antimicrobial metals and metal-containing compounds such as silver containing antimicrobials, a halogen-releasing agent or halogen-containing polymer, a thiazole, a thiocynate, an isothiazolin, a cyanobutane, a dithiocarbamate, a thione, a triclosan, an alkylsulfosuccinate, various “naturally occurring” agents for example polyphenols from green or black tea extract, citric acid, chitosan, anatase TiO₂, tourmaline, bamboo extract, neem oil etc, hydrotropes (strong emulsifiers) and chaotropic agents (alkyl polyglycosides) and synergistic combinations thereof.

Typically the cationic antimicrobial and anionic polyelectrolyte are preferably taken in chemically equivalent proportions, so that no substantial excess of either remains after they come in contact with one another on the textile. Thus an equivalent number of positive charges on the cationic antimicrobial may react or complex with the anionic charges of the polyelectrolyte. on the treated textile.

The weight ratio of the cationic antimicrobial and anionic polyelectrolyte therefore may range broadly depending upon factors such as molecular weight and charge density of each. Thus the weight ratio of cationic antimicrobial to anionic polyelectrolyte may range from about 1/99 to 99/1, preferably about 2/50 to about 50/2, most preferably about 10/40 to about 40/10.

The total weight of the cationic antimicrobial on the treated textile may range from about 0.1 to about 10 wt. %, preferably from about 0.1 to about 5 wt. % and most preferably from about 0.2 wt. % to about 2 wt. % wherein the weight percent is based on the total weight of the antimicrobial textile.

The total weight of anionic polyelectrolyte on the treated textile may range from about 0.1 to about 10 wt. %, preferably from about 0.1 to about 5 wt. % and most preferably from about 0.2 wt. % to about 2 wt. % wherein the weight percent is based on the total weight of the treated antimicrobial textile.

The combined total weight of the anionic polyelectrolyte and cationic antimicrobial on the treated textile may range from about 0.1 to about 20 wt. %, preferably from about 0.2 to about 10 wt. % and most preferably from about 0.4 wt. % to about 4 wt. %, wherein the weight percent is based on the total weight of the treated antimicrobial textile.

Once the textile is treated by the cationic antimicrobial and anionic polyelectrolyte, the textile can be characterized by a reduction in microbial activity of at least log 4 against gram positive and gram negative bacteria, preferably E. coli and S. aureus, within 30 minutes of contamination, preferably within 5 minutes of contamination, according to the American Association of Textile Chemists and Colorists (AATCC) standard 100-1999 modified to account for short contact time of the inoculum. The modifications are an increase in bacteria count in the inoculum from 10 E5 to 10 E6 cfu, the use of a superwetting agent such as Dow Corning® Q2-5211 to ensure rapid wetting of the antimicrobial substrate, and a shorter contact time of the bacteria with the substrate (i.e. instead of the 24 hours in the original procedure, contact times of 30 minutes and 5 minutes are used).

### Processing Aids

Other processing aids and formulating components such as wetting agents, colorants, anti-oxidants and other stabilizers, antistats, surfactants, rheology control agents, vitamins, botanical extracts, scents, odor control agents may also be employed.

### Method of Preparation

Also provided is a method by which the present antimicrobial textiles are prepared as described above under Summary of the Invention.

Textiles comprised of fibers formed from synthetic polymers treated with the polyelectrolyte and cationic antimicrobial as described above can be fabricated according to a number of processes which comprise adhering the select cationic antimicrobial agents to the textile using anionic polyelectrolytes.

The polyelectrolytes and antimicrobial compounds may be applied to the textile together as parts of a single composition, or individually in separate steps. Typically, the polyelectrolyte and the cationic antimicrobial are applied as part of a solution, for example, an aqueous solution, but in some cases, suspensions may be used. Any standard application method may be employed, e.g., padding, spraying, simple immersion or other coating method. Any of the solutions or suspensions applied during processing steps may also include a processing aid such as an alcohol, wetting agent, surfactant, viscosity modifier, binding agent surface modifier, salts, pH-modifiers, etc.

As polypropylene and many other synthetic fibers are hydrophobic it may in some cases be useful to modify the surface of the fibers to improve wetting so the aqueous solutions can be applied to the nonwoven fabric more quickly and evenly. Many methods are known in the art and include surface active additives like IRGASURF HL 560 or plasma surface treatment to add hydrophilic functionality to the surface of the fibers. Additionally, melt blending of additives with the synthetic polymer during formation of the fibers to impart hydrophilic functionality is possible.

For example, the antimicrobial textile wherein the synthetic polymer is polypropylene and may comprise a surface active additive incorporated into the polypropylene before, after or during fiber extrusion.

The application of the anionic polyelectrolyte may be applied directly to the synthetic fibers which will form the textile or directly to the textile formed from synthetic fibers before, after or simultaneously with application of the cationic antimicrobial.

Preferably, the anionic polyelectrolyte is applied to the textile substrate or fibers which will form the textile followed by application of the cationic antimicrobial.

Most preferably, the method is carried out using the order of steps below:

i.) 0.1 to 10 wt % of the anionic polyelectrolyte in an aqueous solution is applied to the textile substrate or fibers which will form the textile, wherein the textile is comprised of fibers formed from synthetic polymer
ii.) the treated substrate or treated fibers are allowed to at least partially dry, and
iii.) 0.1 to 10 wt. % of an aqueous solution of cationic antimicrobial is applied to the treated and at least partially dried textile substrate or fibers which will form the textile of step iii.), wherein the weight percent is based on the total weight of the treated textile or fibers
and
said synthetic polymer is a polyolefin, polyester, polyamide, polylactic acid or polyglycolic acid.

The anionic polyelectrolyte may be applied in a solution or suspension. Normally the anionic polyelectrolyte will be soluble or dispersible in water but other solvent may also be used such as alcohols i.e. methanol and ethanol.

The polyelectrolyte and antimicrobial can be applied to the material substrate via conventional saturation processes such as a so-called “dip and squeeze” or “padding” technique. The “dip and squeeze” or “padding” process can coat both sides and the bulk of the substrate with the antimicrobial composition. When dipped in a bath, the bath may be a solution containing all components, or multiple step processing using separate solutions for individual components. Alternatively, components, or some of the components can be applied by spraying a solution of the component or components.

For example a sheet of non-woven fabric, e.g., a polypropylene nonwoven fabric can be soaked in an aqueous solution of carboxymethyl cellulose until completely wetted. The excess solution is removed by padding and then the sheet is air dried followed by drying in an 80° C. oven after which the antimicrobial is applied, for example, by spraying an aqueous solution of the cationic antimicrobial onto the surface of the textile.

Further discussion of preparation methods can be found in the literature, for example the patents and published applications already incorporated by reference such as US Pub App. No. 2007/0048356 and U.S. Pat. No. 4,721,511.

In certain cases, the polyelectrolyte and antimicrobial of the invention are applied to only one side of the fabric or article. It may be desirable, when treating a multilayered fabric, to apply the polyelectrolyte and antimicrobial to only one of the layers. For example, a hospital gown may be prepared from a non-woven material wherein only the side away from the patient is treated according to the invention, thus the exterior of the garment which is exposed to contamination is treated while the side covering the patient is free of the antimicrobial treatment. Any method of contacting the surface with the polyelectrolyte and antimicrobial may be employed, such as spraying, drawdown etc. Common techniques known to persons in the nonwoven textile industry useful for this purpose include rotary screen, reverse roll, Meyer-rod (or wire wound rod), Gravure, slot die, gap-coating, among others.

The choice of processing techniques is dependent on a number of factors, which include, but are not limited to: 1) viscosity, 2) solution concentration or solids content, 3) the amount of material to be deposited on the substrate, 4) the surface profile of the substrate to be coated, etc. Often, the coating solution will require some formulation modifications of concentration (or solids content), viscosity, wettability or drying characteristics to optimize performance.

The concentration of the polyeletrolyte and antimicrobial solutions and the amount sprayed or otherwise applied onto the textile is readily adjusted to achieve the desired loading. Polyelectrolyte and antimicrobial loading of from about 0.1 to 10 weight have been found to be useful and loadings from about 0.2 to about 5 wt/wt % for each component weight percent based the total weight of the treated antimicrobial textile were found to be very effective. Higher loadings of either component may be useful in certain applications, but are typically not required.

The textile, preferably non-woven may be treated with the polyeletrolyte and antimicrobial on a single side of the material or on both sides. If the textile, preferably non-woven has multiple layers, it may be desirable to treat only a single layer. The antimicrobial solution can be selected so that it permeates only a part of the material, e.g., up to about 15 micron of a non-woven fabric, but it is also possible to fully saturate the material throughout its bulk if desired.

The textile substrate, preferably non-woven, which is treated with the polyelectrolyte and antimicrobial of the present invention can be a fabric or fibers forming a fabric which is subsequently used to make a finished article, or the polyelectrolyte and antimicrobial may be applied to a finished article comprising the textile.

One embodiment of the invention provides protective articles comprising the non-woven composition comprising synthetic polymer fibers, quaternary ammonium compounds, and anionic polyelectrolytes of the invention. Commercial articles produced using the compositions and methods of the invention include, among others, a protective article worn by patients, healthcare workers, or other persons who may come in contact with potentially infectious agents or microbes, including an article of clothing such as a gown, robe, face mask, head cover, shoe cover, or glove; alternatively, the protective article may include a surgical drape, surgical fenestration or cover, drape, sheets, bedclothes or linens, padding, gauze dressing, wipe, sponge and other antimicrobial articles for household, institutional, health care and industrial applications. In certain embodiments, the article contains the quaternary ammonium compounds and anionic polyelectrolytes on only one surface, for example the surface of a face mask which will face away from the body and possibly be exposed to pathogens. Nonwoven wipes are particularly embodied by the invention.

The non-woven substrate material is normally a multi layered material. For example, an outer or inner fabric may be layered to another sheet ply, e.g., a filter or barrier media. In many embodiments, not all of the other layers need to be treated with the present antimicrobial treatment. In one particular embodiment, only one layer of a layered polyolefin fabric is treated with the polyelectrolyte and antimicrobial. For example, a SMS polypropylene fabrics which comprise a spunbond polypropylene layer on each face of a meltbound polypropylene layer are common in protective garments such as face masks and other disposable garments used in hospital settings. Often, only the surface of the fabric that faces away from the body, and exposed to contamination, is treated with an antimicrobial preparation. One embodiment of the invention relates to the treatment of only the “outer layer” of such materials and articles.

The feel of a fabric, especially when held in close contact with the skin is an important consideration, especially with synthetic fibers that may not be sufficiently soft or supple. Additives incorporated into the polypropylene fibers can improve the hydrophilicity of the fibers and impart a soft, comfortable feel to polypropylene non-woven fabrics. The commercial product IRGASURF HL 560 is an example of this type of additive. It has been found that the polyelectrolyte and antimicrobial combination of the instant invention performs extremely well on fabrics treated with such products.

In some embodiments of the invention, the hydrophilic additives may be present on both surfaces of the fabric, in other embodiments, only the side of the fabric contacting the wearer contains the hydrophilic additives. In one embodiment a fabric is prepared where one surface contains the antimicrobial components of the invention and the other surface contains the hydrophilic additives.

Binding quaternary ammonium salts to surfaces such as polypropylene which is a non-polar polymer and contains no hydroxyl or other functionality that might complex with the salt can create difficulties and binders are often employed for this purpose. However, binders that are effective in preventing the leaching or loss of the ammonium salt can hinder its antimicrobial activity.

The selected polyelectrolyes and antimicrobial compounds of the invention create a highly active and durable finish (leach resistant) to the nonwoven textile. The durability can be illustrated by soaking a sheet prepared by the present methods in water for one hour, removing the sheet from the water bath, rinsing with fresh water and then spraying with an indicator dye bromophenol blue. Bromophenol blue has a high affinity for the cationic antimicrobial of the invention. The retention of the blue dye on the fabric indicates that the cationic antimicrobial is durably bound to the fabric and has not been rinsed away with the water soak.

The durability of the invention does not compromise the antimicrobial activity and the high quick kill efficiency is maintained, i.e., at least a log 4 reduction in colony forming units per sample [cfu/sample] within 30 minutes and preferably 5 minutes of exposure. For example, using a modification of AATCC 100 test method to assess the antimicrobial finish on the textiles, cultured bacteria samples were applied to a non-woven PP fabric swath of the invention comprising 2.2 wt/wt % of carboxymethyl cellulose and 3.4 wt/wt % of cetyltrimethylammonium chloride and after 5 minutes a greater than log 4.8 reduction of E. coli and greater than log 4.2 reduction of S. aureus was measured. Details are found in the Experimental section.

The standard 100-1999 was modified to account for short contact time of the inoculum. The modifications are an increase in bacteria count in the inoculum from 10 E5 to 10 E6 cfu, the use of a superwetting agent such as Dow Corning® Q2-5211 to ensure rapid wetting of the antimicrobial substrate, and a shorter contact time of the bacteria with the substrate (i.e. instead of the 24 hours in the original procedure, contact times of 30 minutes and 5 minutes are used).

Cetyltrimethyl ammonium chloride has shown excellent antimicrobial activity in the present invention and carboxymethyl cellulose, alginic acid or poly(ethylene-co-acrylic acid), have each proven to be excellent choices as polyelectrolye. One preferable embodiment employs carboxymethyl cellulose as the polyelectrolyte. One most preferable embodimient provides for the use of cetyltrimethyl ammonium chloride along with carboxymethyl cellulose, alginic acid or poly(ethylene-co-acrylic acid), for example cetyltrimethyl ammonium chloride as antimicrobial and carboxymethyl cellulose as the polyelectrolyte.

This invention provides a leach resistant antimicrobial textile, preferably a non-woven and a process for making such a fabric and an article comprising said fabric, e.g., a hospital gown, surgical drape or like product that provides permanent, quick kill, antimicrobial capacity yet the antimicrobial agent is not readily extracted (leached) from the textile in use.

These novel antimicrobial fabrics/textiles/compositions are superior to existing materials because the antimicrobial action is much quicker and thus far more effective in reducing the potential of transmitting harmful pathogens in a healthcare facility. The antimicrobial textile/composition exhibits at least a log 4 CFU reduction within a period of about 5 minutes after contact with various species of a broad spectrum of microorganisms. The method of determining the antimicrobial activity is described below and is further detailed in AATCC standard 100-1999.

### EXAMPLES

Antimicrobial activity is tested following the American Association of Textile Chemists and Colorists (AATCC) standard 100-1999 for the assessment of antibacterial finishes on textile materials which has been modified to account for the short contact time used to evaluate the fast acting antimicrobial textiles. In the method, textiles treated with an antimicrobial finish are inoculated with a defined cell count of a specific test organism. Untreated surfaces are also inoculated and serve as blank controls. After incubation the cell count on the antimicrobially treated surfaces is determined and compared to the cell count of the untreated control. Zero hour cell count is also determined for the control panels.

Selection of the test strains depend on the target application for the test materials. The most commonly used strains are:

Staphylococcus aureus *ATCC 6538 (S.a. 16), according to AATCC100
Staphylococcus aureus **DSM 799
Klebsiella pneumoniae ATCC 4352 (K.p. 35), according to AATCC100
Escherichia coli ATCC 10536 (E.c. 27), alternative gram-
Escherichia coli DSM 682
Aspergillus niger ATCC 6275 (A.n. 50), black mold fungus
Aureobasidium pullulans DSM 2404 (A.p. 94)
Penicillium funiculosum DSM 1960 (P.f. 57)

### *ATCC—American Type Culture Collection

### **DSMZ—German Collective of Microorganisms and Cell Cultures

For the following examples, Bacteria, Escherichia coli gram (−) and Staphylococcus aureus gram (+), are grown in casein-soy meal peptone broth for 16-24 hours at 37° C. and then diluted with 0.85% NaCl containing 0.5% Caso-Broth broth to provide a suspension with a concentration of ˜10⁷ cfu/ml. Prior to inoculation of the test samples, the concentration is adjusted to 10⁶ cfu/ml with sterile deionised water at pH 7.4. Dow corning® Q2-5211 superwetting agent is added to the inoculum at a concentration of 0.01%.

Two samples per antimicrobial finish or coating are inoculated. Each sample is put in a sterile Petri dish and inoculated with an appropriate amount of bacterial suspension, typically 100 μl-200 μl, in the following examples 200 μl is used of a suspension resulting in a final concentration of bacteria or fungi on the sample of ˜10⁶ cfu. During inoculation, the liquid must be completely absorbed or at least evenly distributed on the test surface. The samples are NOT covered by glass slides or any other cover.

In the following tests, the samples inoculated with bacteria are incubated in a humid chamber at 37° C. for 5 minutes.

### Elution of Cells and Cell Count Determination

After incubation, the surviving organisms are collected from textile samples by transferring the samples into “Stomacher bags” filled with 10 ml inactivation buffer which are kneaded for 1 minute. The surviving organisms are collected from non-textile samples by adding 10 ml inactivation buffer to the Petri containing the sample and shaking the dish for 1 minute. The inactivation buffer is a phosphate buffer 0.07 M at pH 7.4 containing 1% TWEEN 80 and 0.3% lecithin and prevents any active antimicrobial from further interfering with cell growth. One ml of the liquid from either the bags or dishes is removed and diluted with sterile deionized water in steps to provide dilutions of ten fold and 1,000 fold.

100 μl of the undiluted suspensions and of the 10 and 1000 dilutions are plated out by means of a spiral plater onto Tryptic Soy Agar with inactivating agents (MERCK #18360). The plates are then incubated at 37° C. for 24-48 hours depending on bacteria used. After incubation, the visible colonies are counted and the results are given as colony forming units per sample [cfu/sample] according to the following formula cfu/plate×dilution factor×10×10.

### Example 1

### Preparation of Antimicrobial Polypropylene Nonwoven Fabric

A sheet of polypropylene nonwoven fabric (30 gsm) is soaked in a 1% aqueous solution of carboxymethyl cellulose, CMC (average M.W. 90000, degree of substitution 0.7) until completely wetted. The excess solution is then removed by padding and then the sheet is air dried followed by drying in an 80° C. oven for at least one hour. The resulting sheet contains 2.2 wt/wt % of carboxymethyl cellulose based on the total weight of the fabric. An aqueous solution of the cationic antimicrobial cetyltrimethylammonium chloride is sprayed onto the surface of the carboxymethyl cellulose treated textile and the resulting fabric is dried to provide a polypropylene nonwoven sheet containing 2.2 wt/wt % of carboxymethyl cellulose and 3.4 wt/wt % of cetyltrimethylammonium chloride based on the total weight of the fabric.

The durability is illustrated by soaking the sheet in water for one hour, removing the sheet from the water bath, rinsing with fresh water and then spraying with an indicator dye bromophenol blue. The retention of the blue dye to the fabric indicates that the cationic antimicrobial is durably bound to the fabric and has not been rinsed away with the water soak.

### Example 2

### Antimicrobial Activity

A polypropylene nonwoven sheet prepared according to example 1 and containing 2.2 wt/wt % of carboxymethyl cellulose and 3.4 wt/wt % of cetyltrimethylammonium chloride is innoculated with Escherichia coli gram (−) and Staphylococcus aureus gram (+) bacteria as described above. The innoculated samples are incubated in a humid chamber at 37° C. for 5 minutes before transferring the samples into “Stomacher bags” as above. The sheet showed a greater than log 4.8 reduction against E. coli and a greater than log 4.2 reduction against S. aureus. Even after soaking treated textile samples in water for one hour before testing for antimicrobial action, the fabric still displayed a greater than log 4 reduction against both E. coli and S. aureus.

### Example 3

### Demonstration of Leach Resistance of Antimicrobial Polypropylene Nonwoven Fabric

Two sheets of polypropylene nonwoven fabric (30 gsm) are soaked in a 0.5% aqueous solution of carboxymethyl cellulose (average M.W. 90000, degree of substitution 0.7) until completely wetted. The excess solution is then removed by padding and then the sheets are air dried followed by drying in an 80° C. oven for at least one hour. The resulting sheets contains 1.7 wt/wt % of carboxymethyl cellulose based on the total weight of the fabric. One sheet is sprayed with a 0.35% aqueous solution of the cationic antimicrobial cetyltrimethylammonium chloride and the other is sprayed with a 0.5% aqueous solution the cationic antimicrobial cetyltrimethylammonium chloride. The resulting fabrics are dried to provide a polypropylene nonwoven sheet containing 1.7 wt/wt % of carboxymethyl cellulose and 1.2 wt/wt % and 2.0% respectively of cetyltrimethylammonium chloride based on the total weight of the fabric.

The leach resistance is illustrated by soaking a segment of both sheets in water for one hour, removing the sheets from the water bath, rinsing with fresh water then drying.

TABLE I

| | E. coli | S. aureus |
|---|---|---|
| | ATCC 10536 | ATCC 6538 |
| Nonwoven Treatment | [log-reduction] | [log-reduction] |
| 1.7%% CMC; 1.2% cetyl | >4.8 | >4.4 |
| | >4.8 | >4.4 |
| 1.7%% CMC; 1.2% cetyl | 4.3 | >4.4 |
| Soaked in water for 1 hr | 4.0 | >4.4 |
| 1.7% CMC; 2.0% cetyl | >4.8 | >4.4 |
| | >4.8 | >4.4 |
| 1.7% CMC; 2.0% cetyl | 4.8 | >4.4 |
| Soaked in water for 1 hr | 4.5 | >4.4 |

Table I records the log-reduction of a section of the treated nonwoven described in Example 3 tested for quick kill activity. Another section of the same sample was soaked in water for 1 hour to remove any leachables. After soaking the textile segment was rinsed with more water, dried then tested for antimicrobial activity. The high activity observed in both indicates that very little of the active components were leached from the sample.

### Example 4

### Comparative Activity of U.S. Application No. 2007/48356

US patent application 2007/48356 A1 discloses a claimed fast acting antimicrobial treatment for nonwovens. One exemplified composition is a combination of polyhexamethylene biquanide hydrochloride (PHMB), citric acid and a surfactant. Three treated polypropolyene (PP) nonwoven samples are prepared by saturating the nonwovens with an aqueous solution containing 0.5% PHMB, 3% citric acid and 0.3% of the one of the following surfactants: Glucopon 220, Crodacel QM or xylitol. The excess solution is removed by padding and then the sheets are dried. The antimicrobial results below indicate that the compositions of the present invention are significantly more active than previously disclosed compositions. When treated samples were soaked in water for 1 hour all activity was lost indicating that the treatment according to US 2007/48356 is not durable and leaches with exposure to moisture.

TABLE 2
Five Minute Quick Kill Results for PHMB Compositions on a
PP Nonwoven Substrate.

| | Treatment | E. coli | S. aureus |
|---|---|---|---|
| Composition | Loading | [log-reduction] | [log-reduction] |
| PHMB/Citric acid | 2.7% | <1 | 2.5 |
| Glucopon 220 | | <1 | 3.7 |
| PHMB/Citric acid | 2.7% | <1 | <1 |
| Glucopon 220 | Soaked 1 hr | <1 | <1 |
| PHMB/Citric acid | 1.4 | <1 | <1 |
| Crodacel QM | | <1 | <1 |
| PHMB/Citric acid | 1.4 | <1 | <1 |
| Crodacel QM | Soaked 1 hr | <1 | <1 |
| PHMB/Citric acid | 2.8 | 1.7 | <1 |
| xylitol | | 1.6 | <1 |
| PHMB/Citric acid | 2.8 | <1 | <1 |
| xylitol | Soaked 1 hr | <1 | <1 |

### Example 5

### Advantage of Trialkylammomium Salts Over PHMB

The examples below are treated as above using the standard method AATCC 100-1999 for the assessment of antibacterial finishes on textile materials. The results in the Table 3 show the trialkylammonium salts and anionic polyelectrolye treatment on the nonwoven (the invention) are superior to the treatment of the nonwoven with the polymeric antimicrobial PHMB

### Five Minute Quick Kill Results for PHMB Compositions on a PP Nonwoven Substrate.

| | E. coli | S. aureus |
|---|---|---|
| Loading Levels | [log-reduction] | [log-reduction] |
| 2.3% CMC | 4.0 | >4.2 |
| 3.4% Cetyltrimethylammonium chloride | 4.3 | >4.2 |
| 2.3% CMC | 1.6 | <1 |
| 3.4% PHMB | 3.3 | 1.2 |

1. An antimicrobial textile comprising
a) a treated textile substrate comprised of fibers formed from synthetic polymer, said treated substrate comprises
b) 0.1% to 10 wt. % of an anionic polyelectrolyte, and
c) 0.1% to 10 wt. % of a cationic antimicrobial agent of the formula: 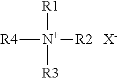
wherein R₁, R₂, R₃ and R₄ are independent of each other C₁₋₂₀ alkyl, said alkyl substituted by one or more hydroxy or benzyloxy group and/or interrupted by one or more oxygen, C₇₋₁₅ aralkyl, or said aralkyl substituted by one or more C₁₋₂₀ alkyl, hydroxy, C₁₋₂₀ alkyloxy and/or benzyloxy groups, and
X⁻ is a halide, hydroxide, phosphate, phosphonate, carbonate, sulfate or carboxylate anion,
the synthetic polymer is a polyolefin, polyester, polyamide, polylactic acid, polyglycolic acid or mixtures thereof,
and
d) optionally a nonionic surfactant,
and the wt. % is based on the total weight of the antimicrobial textile.

2. The antimicrobial textile according to claim 1 which is characterized by a reduction in microbial activity of at least log 4 against gram positive and gram negative bacteria within 30 minutes of contamination according to modified AATCC standard 100-1999.

3. The antimicrobial textile according to claim 1, wherein the textile is a nonwoven.

4. The antimicrobial textile according to claim 1, wherein the anionic polyelectrolyte is selected from the group consisting of carboxymethyl cellulose, alginic acid, poly(ethylene-co-acrylic acid), poly(acrylamide-co-acrylic acid), polymers and copolymer of acrylic acid or methacrylic acid, polymers and copolymer of maleic acid, itaconic or crotonic acid and mixtures thereof.

5. The antimicrobial textile according to claim 1, wherein the synthetic polymer is a polyolefin, polyester or polyamide or mixtures thereof.

6. The antimicrobial textile according to claim 1, wherein the synthetic polymer is a polypropylene, a polylethylene, a polypropylene/polylethylene copolymer, a PET, a PEN, a nylon a styrenic co-block polymer or mixtures thereof.

7. The antimicrobial textile according to claim 1, wherein the textile is a nonwoven and the synthetic polymer is polypropylene.

7. The antimicrobial textile according to claim 1, wherein the anionic polyelectrolyte is carboxymethyl cellulose, alginic acid or poly(ethylene-co-acrylic acid).

8. The antimicrobial textile according to claim 1, wherein at least one of the groups R₁, R₂, R₃ and R₄ in the cationic antimicrobial is alkyl group of 6 or more carbon atoms or a benzyl group.

9. The antimicrobial textile according to claim 1, wherein the cationic antimicrobial is selected from the group consisting of an alkyldimethylbenzylammonium salt, benzethonium salt, didecyldimethylammonium salt and cetyltrimethylammonium salt.

10. The antimicrobial textile according to claim 1, wherein the anionic polyelectrolyte is carboxymethyl cellulose.

11. A method of producing an antimicrobial fibrous textile or an article containing an antimicrobial fibrous textile comprised of fibers formed from synthetic polymer comprising the steps of treating at least one surface of the textile with an anionic polyelectrolyte and a cationic antimicrobial agent of the formula: 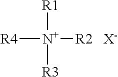
wherein R₁, R₂, R₃ and R₄ are independent of each other C₁₋₂₀ alkyl, said alkyl substituted by one or more hydroxy or benzyloxy group and/or interrupted by one or more oxygen, C₇₋₁₅ aralkyl, or said aralkyl substituted by one or more C₁₋₂₀ alkyl, hydroxy, C₁₋₂₀ alkyloxy and/or benzyloxy groups, and
X⁻ is a halide, hydroxide, phosphate, phosphonate, carbonate, sulfate or carboxylate anion, for example, chloride, bromide, iodide, nitrate, methosulfate or acetate,
wherein the treated textile is characterized by a reduction in microbial activity of at least log 4 against gram positive and gram negative bacteria within 5 minutes of contamination according to AATCC standard 100-1999,
and said synthetic polymer is a polyolefin, polyester, polyamide, polylactic acid or polyglycolic acid.

12. A method according to claim 11 wherein the cationic antimicrobial agent and anionic polyelectrolyte are in separate aqueous solutions and the surface of the textile is treated with the aqueous solution of the anionic polyelectrolyte followed by treatment with the aqueous solution of the cationic antimicrobial agent.

13. The antimicrobial textile according to claim 6, wherein the synthetic polymer is polypropylene and comprise a surface active additive incorporated into the polypropylene before, after or during fiber extrusion.

14. An article comprising the antimicrobial textile according to claim 1.

15. An article according to claim 14 which is a surgical drape, surgical fenestration or cover, drape, sheets, linens, padding, gauze dressing, wipe or a garment selected from the group consisting of a gown, robe, face mask, head cover, shoe cover, or glove.

16. A kit of parts for the manufacture of an antimicrobial nonwoven textile, comprising a first part
(A) comprising an anionic polyelectrolyte and a second part (B) comprising a cationic antimicrobial agent of the formula: 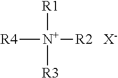
wherein R₁, R₂, R₃ and R₄ are independent of each other C₁₋₂₀ alkyl, said alkyl substituted by one or more hydroxy or benzyloxy group and/or interrupted by one or more oxygen, C₇₋₁₅ aralkyl, or said aralkyl substituted by one or more C₁₋₂₀ alkyl, hydroxy, C₁₋₂₀ alkyloxy and/or benzyloxy groups, and
X is a halide, hydroxide, phosphate, phosphonate, carbonate, sulfate or carboxylate anion, for example, chloride, bromide, iodide, nitrate, methosulfate or acetate,
which parts when applied to the textile or fiber forming the textile, form an antimicrobial textile according to claim 1.
